(19) United States
(12) Patent Application Publication
(10) Pub. No.: US 2018/0346714 A1
(43) Pub. Date: Dec. 6, 2018

(54) POLYMER COMPOSITIONS COMPRISING A POLYARYLETHERKETONE AND A POLYCARBONATE POLYMER AND FORMED ARTICLES OBTAINABLE THEREFROM

(71) Applicant: SOLVAY SPECIALTY POLYMERS USA, LLC, Alpharetta, GA (US)

(72) Inventors: Corinne BUSHELMAN, Cumming, GA (US); Mohammad Jamal EL-HIBRI, Atlanta, GA (US)

(21) Appl. No.: 15/757,911

(22) PCT Filed: Sep. 9, 2016
(86) PCT No.: PCT/EP2016/071341

§ 371 Date: Mar. 6, 2018

Related U.S. Application Data
(60) Provisional application No. 62/216,085, filed on Sep. 9, 2015.

(30) Foreign Application Priority Data
Nov. 23, 2015 (EP) 15195912.9

(51) Int. Cl. C08L 69/00; C08J 3/20

(52) U.S. Cl. CPC C08L 69/00; C08J 3/201; B29C 47/0004; C08L 2203/20; C08L 2207/53; C08L 2205/035

(57) ABSTRACT

A composition [composition (C)] including: a) an aromatic polycarbonate polymer [PC polymer (P1)]; b) a polaryletherketone polymer [PAEK polymer (P2) and c) an impact modifier [impact modifier (IM)] is herein disclosed. A method for the manufacture of composition (C) and the use of composition (C) for the manufacture of formed articles, in particular parts of electronic devices, more particularly parts of portable or mobile electronic devices are also herein disclosed. Composition (C) may exhibit the following combination of properties: —high impact resistance; —good aesthetic characteristics (colorability); and —high chemical resistance.

### CROSS-REFERENCE TO RELATED APPLICATIONS

This application claims priority to U.S. Provisional Application No. 62/216,085, filed Sep. 9, 2015, and European Application No. EP 15195912.9, filed Nov. 23, 2015, each of which is incorporated by reference herein in its entirety.

### TECHNICAL FIELD

The present invention relates to polymer compositions comprising a polyaryletherketone and a polycarbonate polymer, said compositions having improved toughness, high chemical resistance and good colorability and to a method for their manufacture. The compositions can be conveniently used for the manufacture of consumer's products, in particular of parts of electronic devices.

### BACKGROUND ART

Nowadays, mobile electronic devices, such as mobile phones, personal digital assistants (PDAs), laptop computers, MP3 players and so on, are in widespread use around the world. Mobile electronic devices are getting smaller and lighter for even more portability and convenience, while at the same time are becoming increasingly capable of performing more advanced functions and services, both due to the development of the devices and the network systems.

For the sake of convenience it is often desirable that these devices are small and lightweight; however, they still need to possess a certain structural strength, so that they are not damaged by normal handling and occasional drops. Thus, usually built into such devices are structural parts whose primary function is to provide strength and/or rigidity and/or impact resistance to the device, and possibly also provide mounting places for various internal components of the device and/or part or all of the mobile electronic device case (outer housing). While in the past low density metals, such as magnesium or aluminum, were the materials of choice for such structural parts, synthetic resins have progressively at least partially replaced such metals, for costs reasons (some of these less dense metals such as magnesium are quite expensive and manufacturing the often small and/or intricate parts needed is expensive), for overriding design flexibility limitations, for further weight reduction, and for providing unrestricted aesthetic possibilities, thanks to the colorability of the same. Another problem associated to the use of metals in electronic devices is that they are not transparent to radiofrequencies; therefore, antennas of electronic devices cannot be covered with metals. Plastic parts of electronic devices are hence made of materials that are easy to process into various and complex shapes, are able to withstand the rigors of frequent use, including outstanding impact resistance, and which can meet challenging aesthetic demands while not interfering with their intended operability. Frequently, plastic parts of electronic devices are made from polycarbonates, in particular from polycarbonates obtained by polycondensation of phosgene and bisphenol A; indeed, polycarbonates are endowed with outstanding impact properties and good aesthetic characteristics (color).

Nevertheless, in certain cases not all the structural parts of mobile electronic devices can be replaced with plastic materials and metal/synthetic resins assemblies are often encountered. In such cases, metal parts, e.g. aluminum parts and/or aluminum/plastic composite parts present in mobile devices are submitted generally to anodization, i.e. to electrochemical processes whose aim is to build an oxide layer on the aluminum surface, notably through the use of aggressive chemicals. In view of the fact that anodization is performed on parts already comprising/assembled into polymeric elements, the polymeric materials must be highly resistant to aggressive acids.

An additional requirement for plastics materials used in mobile electronics part is that they are resistant to consumer chemicals and staining agents that often come into contact with them, in particular with the housings. Typical consumer chemicals and staining agents include: lotions (hand lotions, sunscreen lotions, etc.), makeup (such as lipstick, lip gloss, lip liner, lip plumper, lip balm, foundation, powder, blush), food (olive oil, coffee, red wine, mustard, ketchup and tomato sauce), dyes and pigments (such as those found in dyed textiles and leather used for the manufacture of portable electronic devices housings). In contact with these staining agents, the portable electronic devices housings may be easily stained: anti-stain properties are hence desired for maintaining good aesthetic appearance of said devices, in particular when they are white or have bright or clear colors.

Even worse, the exposure to consumers chemicals can lead to premature failure and/or environmental stress cracking of the part in case the chemical resistance of the plastic material is not sufficient.

In particular, the chemical resistance of polycarbonates is poor and it is well known that they can undergo dramatic failure due to exposure to some of the aforementioned chemicals.

There is therefore the need to provide a plastic material which, further to possessing high impact resistance and good aesthetic properties, is endowed with high chemical resistance.

Polysulfones, in particular polyphenylsulfones comprising repeating units of formula:

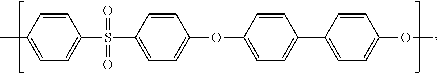

(PPSU), are endowed with high impact and chemical resistance. Unfortunately, because of their initial amber color, higher amounts of pigments and dyes are required in order to produce bright colored formulations with PPSU. In particular, high levels of TiO₂ are needed to obtain a bright white. Due to the high level of pigments, the physical properties of the resulting materials are negatively affected and, in particular, loss of toughness can be observed. Therefore, PPSU is not suitable for wholly replacing polycarbonates in the manufacture of plastic parts of mobile electronic devices when bright colors are desired.

On the other hand, polyaryletherketones (PAEK), in particular polyetheretherketones comprising repeating units of formula:

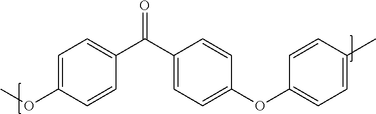

(PEEK) are well known for their exceptional chemical resistance. Their physical properties are not affected even after exposure to harsh chemicals. However, PEEK do not have the high impact performance of polycarbonates or polyphenylsulfones. In addition, obtaining bright colored PEEK formulations is extremely challenging due to the inherent color of the polymers.

There is still therefore the need to provide a material that is endowed with the following combination of properties:
high impact resistance;
good aesthetic characteristics (colorability); and
high chemical resistance.

It is known in the art to mix (or blend) two or more plastic materials together to obtain an optimum balance of the desired properties and also to add impact modifiers, for example acrylic elastomers, to polymers in order to improve their impact resistance. For example, EP 787769 B (GENERAL ELECTRIC COMPANY) discloses polycarbonate and polyester compositions comprising an impact modifier.

However, the impact modification of PAEK polymers is technically challenging, as most impact modifiers would not withstand the high processing temperatures of such polymers (around 400° C.). Mixing a polycarbonate and a PAEK together is also technically difficult. Indeed, while PAEK polymers are usually processed at temperatures around 400° C., polycarbonates are usually processed around 250° C.; therefore, at the high temperature necessary for blending the two polymers together degradation of the polycarbonate is expected.

### SUMMARY OF THE INVENTION

The Applicant has now surprisingly found out that polyaryletherketones (PAEK) and polycarbonates (PC) can be melt-mixed with an impact modifier to provide compositions that are endowed with high impact resistance, good aesthetic characteristics (colorability) and high chemical resistance.

Accordingly, in a first aspect, the present invention relates to a composition [composition (C)] comprising:

a) an aromatic polycarbonate polymer [PC polymer (P1)];

b) a polaryletherketone polymer [PAEK polymer (P2)] and

c) an impact modifier [impact modifier (IM)].

In a second aspect, the invention relates to a method for the manufacture of composition (C) which comprises melt-mixing a polycarbonate (P1), a PAEK polymer (P2), an impact modifier (IM) and any other optional ingredients at a temperature above the melting temperature the PAEK polymer (P2) to provide a molten mixture, followed by extrusion and cooling of the molten mixture.

In a third aspect, the invention relates to a method for the manufacture of a formed article, in particular a part of an electronic device, preferably a part of a mobile electronic device, which comprises:
providing a composition (C) as defined above: and
moulding the composition to provide a formed article.

In a fourth aspect, the invention relates to formed articles, in particular parts of electronic devices, preferably parts of mobile electronic devices, comprising (or made from) composition (C).

### General Definitions

For the sake of clarity, throughout the present application:
any reference back to each generic definition of the ingredients of composition (C), e.g. “polymer (P1), “polymer (P2)”, etc. . . . and to each generic embodiment of the invention is intended to include each specific definition or embodiment falling within the respective generic definition or embodiment, unless indicated otherwise;
the indeterminate article “a” in expressions like “a polymer (P1)”, “a polymer (P2)”, “a polymer (P3)”, etc. . . . is intended to mean “one or more”, or “at least one” unless indicated otherwise;
the use of brackets “( )” before and after names of compounds, symbols or numbers identifying formulae, e.g. “a polymer (P1)”, “a polymer (P2)”, etc . . . , has the mere purpose of better distinguishing that name, symbol or number from the rest of the text; thus, said parentheses could also be omitted;
when numerical ranges are indicated, range ends are included;
the term “halogen” includes fluorine, chlorine, bromine and iodine, unless indicated otherwise;
the term “method” is used as synonym of process and vice-versa;
the adjective “aromatic” denotes any mono- or polynuclear cyclic group (or moiety) having a number of π electrons equal to 4n+2, wherein n is 0 or any positive integer; an aromatic group (or moiety) can be an aryl or an arylene group (or moiety);
an “aryl group” is a hydrocarbon monovalent group consisting of one core composed of one benzenic ring or of a plurality of benzenic rings fused together by sharing two or more neighboring ring carbon atoms, and of one end. Non limitative examples of aryl groups are phenyl, naphthyl, anthryl, phenanthryl, tetracenyl, triphenylyl, pyrenyl, and perylenyl groups. The end of an aryl group is a free electron of a carbon atom contained in a (or the) benzenic ring of the aryl group, wherein an hydrogen atom linked to said carbon atom has been removed. The end of an aryl group is capable of forming a linkage with another chemical group;
an “arylene group” is a hydrocarbon divalent group consisting of one core composed of one benzenic ring or of a plurality of benzenic rings fused together by sharing two or more neighboring ring carbon atoms, and of two ends. Non limitative examples of arylene groups are phenylenes, naphthylenes, anthrylenes, phenanthrylenes, tetracenylenes, triphenylylenes, pyrenylenes, and perylenylenes. An end of an arylene group is a free electron of a carbon atom contained in a (or the) benzenic ring of the arylene group, wherein an hydrogen atom linked to said carbon atom has been removed. Each end of an arylene group is capable of forming a linkage with another chemical group.

### The Aromatic Polycarbonate Polymer [Polymer (P1)]

For the purpose of the present invention, the aromatic polycarbonate (P1) is any polymer of which more than 50 wt. % of the recurring units [recurring units (R1)] comprise at least one optionally substituted arylene group and at least one carbonate group (—O—C(═O)—O).

The arylene group contained in the recurring units (R1) is preferably selected from optionally substituted phenylenes and naphthylenes.

The arylene group contained in the recurring units (R1) can substituted or unsubstituted.

In one embodiment, the arylene group contained in the recurring units (R1) is unsubstituted.

In another embodiment, the arylene group contained in the recurring units (R1) is substituted by at least one substituting group. The substituting group is advantageously selected from: (s-1) C₁-C₂₀ alkyls, (s-2) C₅-C₁₅ cycloalkyls, (s-3) C₁-C₂₀ aryls, (s-4) C₁-C₂₀ alkylaryls, (s-5) C₁-C₂₀ aralkyls, (s-6) C₁-C₂₀ alkenyls, halogens, the partially halogenated homologous of groups (s-1), (s-2), (s-3), (s-4), (s-5) and (s-6), and the perhalogenated homologous of groups (s-1), (s-2), (s-3), (s-4), (s-5) and (s-6).

The recurring units (R1) can be selected from those obtainable by the polycondensation reaction of a carbonic acid derivative, typically diphenyl carbonate Ph-O—C(═O)—O-Ph, wherein Ph is phenyl, or phosgene Cl—C(═O)—Cl, and at least one optionally substituted aromatic diol [diol (D1)] HO—R—OH in which R is a C₆-C₅₀ divalent radical comprising at least one arylene group.

The optionally substituted arylene group of the aromatic diol (D1) is preferably selected from optionally substituted phenylenes and optionally substituted naphthylenes. If the aromatic diol (D1) contains several optionally substituted arylene groups, they are selected independently from each other.

In one embodiment, the arylene group of the aromatic diol (D1) is substituted with at least one substituting group. The substituting group is advantageously selected from (s-1), (s-2), (s-3), (s-4), (s-5), (s-6), halogens, the partially halogenated homologous of radicals (s-1), (s-2), (s-3), (s-4), (s-5) and (s-6), and the perhalogenated homologous of radicals (s-1), (s-2), (s-3), (s-4), (s-5) and (s-6). If several substituting groups substitute the same arylene group, the substituting groups are selected independently from each other. Also, if the aromatic diol (D1) contains several substituted arylene groups, the substituting groups are selected independently from one aromatic diol to another.

The aromatic diol (D1) is preferably selected from aromatic diols complying with formulae (I) and (II) here below:

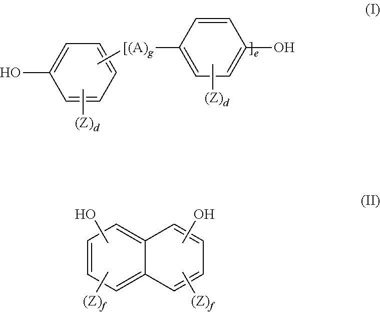

wherein:
A is selected from C₁-C₈ alkylenes, C₂-C₈ alkylidenes, C₅-C₁₅ cycloalkylenes, C₅-C₁₅ cycloalkylidenes, carbonyl atom, oxygen atom, sulfur atom, —SO—, —SO₂— and radicals complying with formula (III) here below:

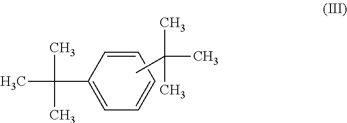

Z is selected from (s-1), (s-2), (s-3), (s-4), (s-5) and (s-6) as above defined; preferably Z is selected from F, Cl, Br, I, C1-C4 alkyls; if several Z radicals are substituents, they may be identical or different from one another;
e denotes an integer from 0 to 1;
g denotes an integer from 0 to 1;
d denotes an integer from 0 to 4; and
f denotes an integer from 0 to 3.

Non limiting examples of aromatic diols (D1) are selected from: hydroquinone, resorcinol, bis-(hydroxyphenyl)-alkanes, bis-(hydroxyphenyl)-ethers, bis-(hydroxyphenyl)-ketones, bis-(hydroxyphenyl)-sulfoxides, bis-(hydroxyphenyl)-sulfides, bis-(hydroxyphenyl)-sulfones, 2,2,4-trimethylcyclohexyl-1,1-diphenol and α,α-bis-(hydroxyphenyl)-diisopropylbenzenes, as well as their nuclear-alkylated compounds. These and further aromatic diols (D1) are described, for example, in U.S. Pat. No. 3,028,356 A; U.S. Pat. No. 2,999,835; U.S. Pat. No. 3,148,172; U.S. Pat. No. 2,991,273; U.S. Pat. No. 3,271,367; and U.S. Pat. No. 2,999,846, all incorporated herein by reference.

Further examples of aromatic diols from which the recurring units (R1) are obtainable are the following bisphenols: 2,2-bis-(4-hydroxy-phenyl)-propane (bisphenol A), 2,4-bis-(4-hydroxyphenyl)-2-methyl-butane,
1,1-bis-(4-hydroxyphenyl)-cyclohexane,
α,α′-bis-(4-hydroxy-phenyl)-p-diisopropylbenzene,
2,2-bis-(3-methyl-4-hydroxyphenyl)-propane,
2,2-bis-(3-chloro-4-hydroxyphenyl)-propane,
bis-(3,5-dimethyl-4-ydroxyphenyl)-methane,
2,2-bis-(3,5-dimethyl-4-hydroxyphenyl)-propane,
bis-(3,5-dimethyl-4-hydroxyphenyl)-sulfide,
bis-(3,5-dimethyl-4-hydroxy-phenyl)-sulfoxide,
bis-(3,5-dimethyl-4-hydroxyphenyl)-sulfone, dihydroxy-benzophenone,
2,4-bis-(3,5-dimethyl-4-hydroxyphenyl)-cyclohexane,
α,α-′-bis-(3,5-dimethyl-4-hydroxyphenyl)-p-diisopropylbenzene,
2,2,4-trimethyl cyclohexyl-1,1-diphenol and
4,4′-sulfonyl diphenol.

Advantageously, aromatic diols (D1) are selected from the above-cited examples.

More advantageously, aromatic diols (D1) are selected from the following list:
2,2-bis-(4-hydroxyphenyl)-propane,
2,2-bis-(3,5-dimethyl-4-hydroxyphenyl)-propane,
2,2,4-trimethyl cyclohexyl-1,1-diphenol and 1,1-bis-(4-hydroxy-phenyl)-cyclohexane.

The most preferred aromatic diol from which the recurring units (R1) are obtainable is 2,2-bis-(4-hydroxyphenyl)-propane (bisphenol A).

The polycarbonate (P1) of the invention may entail in its structure recurring units (R1) obtainable from a carbonic acid derivative and one and only one aromatic diol.

Alternatively, the polycarbonate (P1) of the invention may entail in its structure recurring units (R1) obtainable from a carbonic acid derivative and two, three or more than three aromatic diols. Among the aromatic polycarbonates suitable in the practice of the invention as aromatic polycarbonates (P1) are included phenolphthalein-based polycarbonates, copolycarbonates and terpolycarbonates such as are described in U.S. Pat. No. 3,036,036 and U.S. Pat. No. 4,210,741, both incorporated by reference herein.

The aromatic polycarbonate (P1) may further comprise recurring units (R1*), different from recurring units (R1).

Recurring units (R1*) may be notably those recurring units obtainable by the polycondensation reaction of a carbonic acid derivative and at least one C₁-C₂₀ aliphatic, such as ethylene glycol, neopentylglycol, 1,4-butanediol and 1,5-hexanediol. Recurring units (R1*) may also be those recurring units obtainable by the polycondensation reaction of at least one diacid, such as adipic acid, terephthalic acid and isophthalic acid, and at least one diol selected from C₁-C₂₀ aliphatic diols and aromatic diols such, identical to above described aromatic diols (D1). Among these recurring units (R1*), those recurring units obtainable by the polycondensation reaction of terephthalic acid and/or isophthalic acid, and at least one aromatic diol (D1), are preferred.

Preferably more than 75 wt. % and more preferably more than 90 wt. % of the recurring units of the aromatic polycarbonate (P1) are recurring units (R1). Still more preferably, essentially all, if not all, the recurring units of the aromatic polycarbonate (P1) are recurring units (R1).

According to a particularly preferred embodiment, essentially all, if not all, the recurring units of the aromatic polycarbonate (P1) are recurring units (R1) obtainably by polycondensation reaction of a carbonic acid derivative with bisphenol A.

The aromatic polycarbonate (P1) of the invention can be unbranched or branched; branched polycarbonates (P1) can be obtained in particular by condensing therein small quantities, e.g., 0.05 to 2.0 mol % (relative to the bisphenols) of polyhydroxyl compounds. Polycarbonates of this type have been described, for example, in DE 1570533; DE 2116974; DE 2113374; GB 885442; GB 1079821 and U.S. Pat. No. 3,544,514. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxy-phenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopro-pylidine)-phenol; 2,6-bis-(2′-dihydroxy-5′-methylbenzyl).sub.4-methyl-phenol; 2,4-dihydroxybenzoic acid; 2-(4-hydroxyphenyl)-2-(2,4-dihydroxy-phenyl)-propane and 1,4-bis-(4,4′-dihydroxy-triphenylmethyl)-benzene. Some of the other polyfunctional compounds are 2,4-dihydroxybenzoic acid, trimesic acid, cyanuric chloride and 3,3-bis-(4-hydroxyphenyl)-2-oxo-2,3-dihydroindole.

The aromatic polycarbonate (P1) is preferably unbranched.

The aromatic polycarbonate (P1) can be semi-crystalline (i.e. it has a melting point) or amorphous (i.e. it has no melting point). It is preferably amorphous.

The aromatic polycarbonate (P1) can be prepared by any suitable method.

Suitable methods for the preparation of the polycarbonate (P1) include polycondensation in a homogeneous phase and transesterification. Suitable methods are disclosed in the incorporated herein by reference U.S. Pat. No. 3,028,365; U.S. Pat. No. 2,999,846; U.S. Pat. No. 3,153,008 and U.S. Pat. No. 2,991,273. The preferred method for the preparation of polycarbonate (P1) is the interfacial polycondensation method, wherein the recurring units (R1) are obtained by the polycondensation reaction of a carbonic acid derivative, in particular phosgene, and at least one aromatic diol (D1). Still other suitable methods of synthesis in forming the polycarbonate (P1) are disclosed in U.S. Pat. No. 3,912,688, incorporated herein by reference.

Aromatic polycarbonates suitable as the aromatic polycarbonate (P1) are available on the market. Excellent results were obtained with Macrolon® 3108 polycarbonate, a bisphenol A polycarbonate commercially available from Bayer Material Science LLC, of Pittsburgh, Pa. Other suitable aromatic polycarbonates are Makrolon® 2605, Makrolon® 2805, Makrolon® 3026, Makrolon® 3208 and Makrolon® 3200, all of which are bisphenol A based homopolycarbonates differing in terms of their respective molecular weights and melt flow indexes. A branched polycarbonate such as Makrolon® 1239 can also be used. All Makrolon® products are available from Bayer Material Science LLC, of Pittsburgh, Pa.

The aromatic polycarbonate (P1) may be in the form of pellets and/or powder; advantageously, the polycarbonate (P1) is in the form of pellets.

The composition (C) can comprise one and only one aromatic polycarbonate (P1). Alternatively, it can comprise two, three, or even more than three aromatic polycarbonates (P1).

### The Polyaryletherketone Polymer [Polymer (P2)]

For the purpose of the present invention, the polyaryletherketone polymer (P2) denotes any polymer comprising recurring units, wherein more than 50% moles of said recurring units are recurring units (R2) comprising a —Ar—C(═O)—Ar′— group, wherein Ar and Ar′, equal to or different from each other, are aromatic groups. The recurring units (R2) are generally selected from the group consisting of formulae (J-A) to (J-O) herein below:

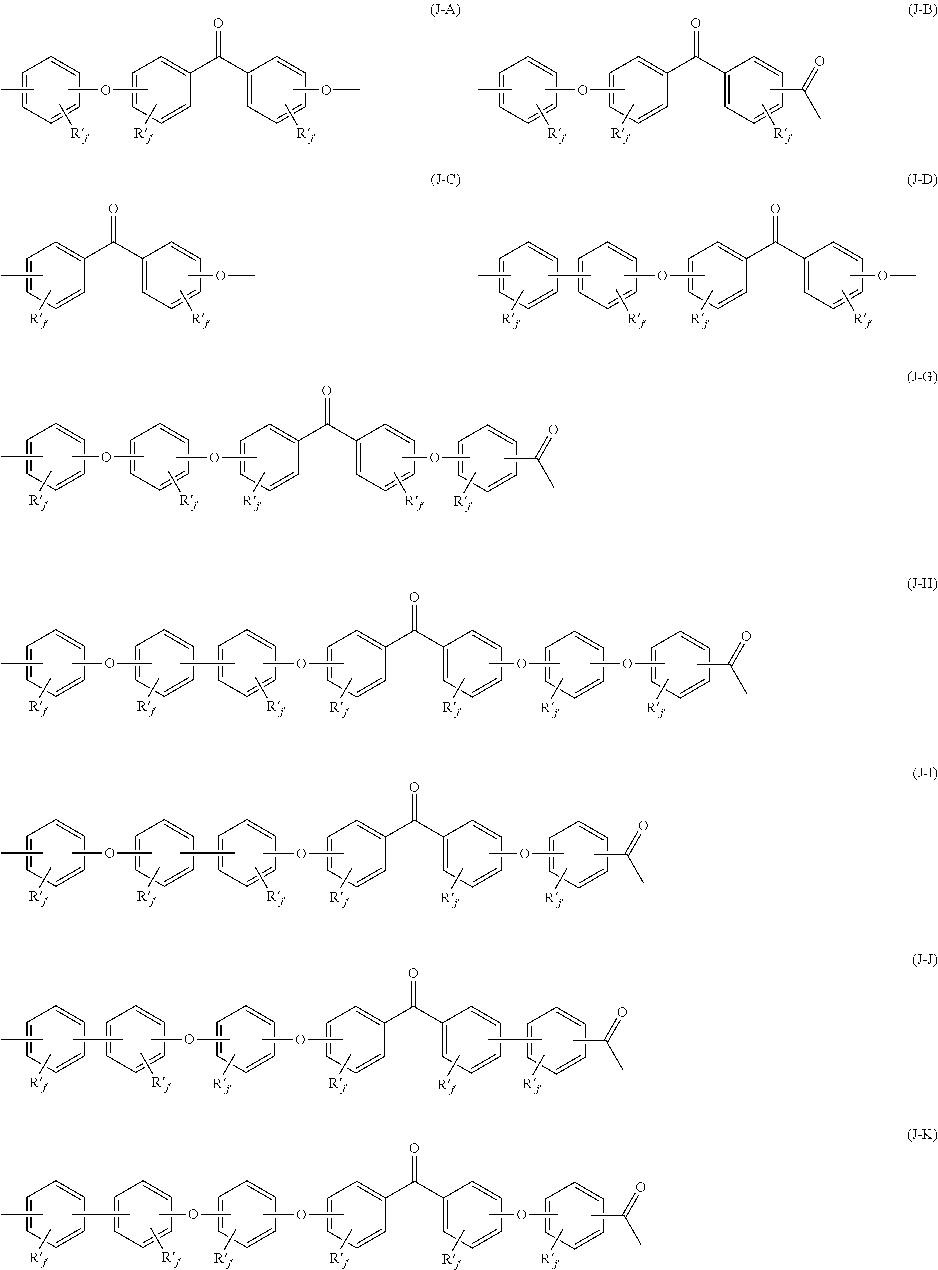

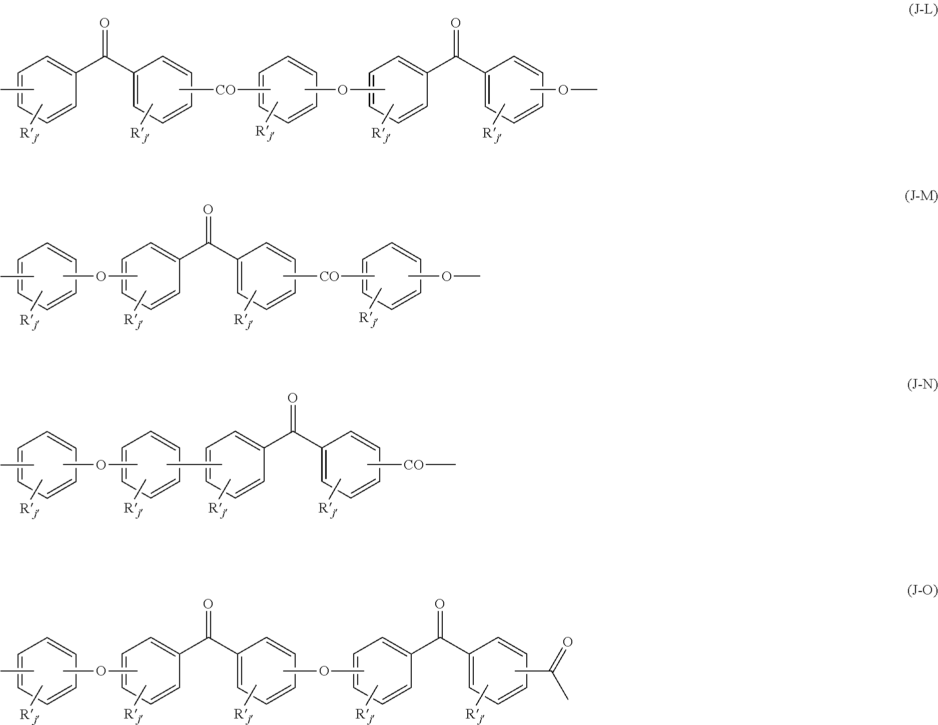

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4.

In recurring unit (R2), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage.

Still, in recurring units (R2), j′ is preferably at each occurrence zero, that is to say that the phenylene moieties have no other substituents than those enabling linkages in the main chain of the polymer.

Preferred recurring units (R2) are thus selected from those of formulae (J′-A) to (J′-O) herein below:

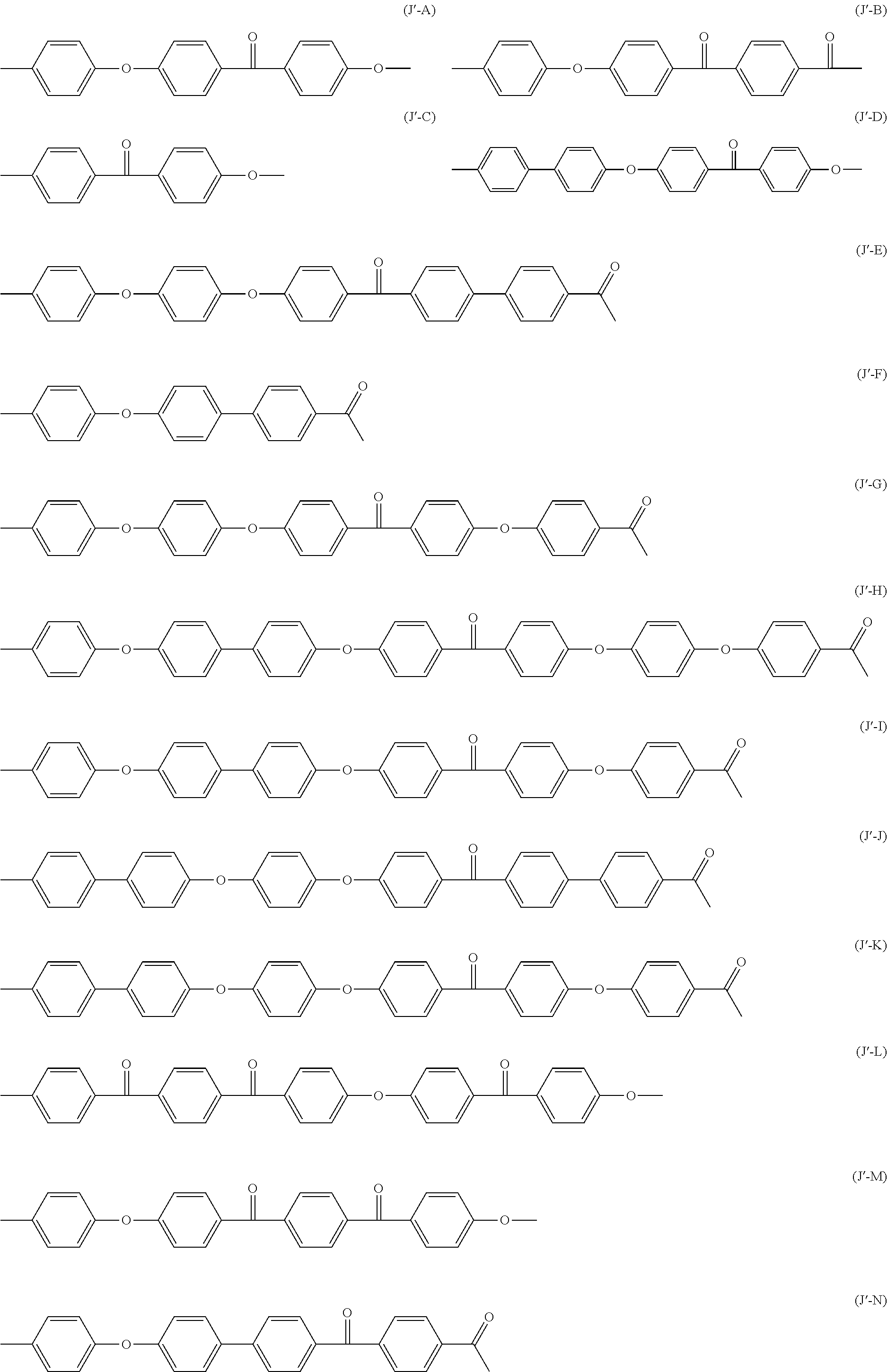

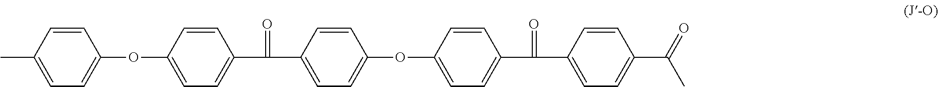

Polyaryletherketones (P2) are generally crystalline aromatic polymers, readily available from a variety of commercial sources. The polyaryletherketones (P2) have preferably reduced viscosities in the range of from about 0.5 to about 1.8 dl/g as measured in concentrated sulfuric acid at 25° C. and at atmospheric pressure. The polyaryletherketones (PAEK) have preferably a melt viscosity (measured at 400° C., 1000 s⁻¹) from about 0.050 to 0.65 kPa-s.

In a preferred embodiment of the invention, at least 50% moles of the recurring units of polyaryletherketones (P2) are recurring units (J′-A). Preferably at least 60% moles, more preferably at least 70% moles, still more preferably at least 80% moles and most preferably at least 90% moles of the recurring units of polyaryletherketones (P2) are recurring units (J′-A). Excellent results were obtained when the polyaryletherketones (P2) contained no recurring unit other than recurring units (J′-A). In exemplary embodiments, substantially all of the recurring units of the polyaryletherketones (P2) are recurring units (J′-A).

In another preferred embodiment of the invention, at least 50% moles of the recurring units of polyaryletherketones (P2) are recurring units (J′-B). Preferably at least 60% moles, more preferably at least 70% moles, still more preferably at least 80% moles and most preferably at least 90% moles of the recurring units of polyaryletherketones (P2) are recurring units (J′-B). Even more preferably, the polyaryletherketone (P2) contains no recurring unit other than recurring units (J′-B). In exemplary embodiments, substantially all of the recurring units of the polyaryletherketones (P2) are recurring units (J′-B).

In yet another preferred embodiment of the invention, at least 50% moles of the recurring units of polyaryletherketones (P2) are recurring units (J′-C). Preferably at least 60% moles, more preferably at least 70% moles, still more preferably at least 80% moles and most preferably at least 90% moles of the recurring units of polyaryletherketones (P2) are recurring units (J′-C). Even more preferably, the polyaryletherketone (P2) contains no recurring unit other than recurring units (J′-C). In exemplary embodiments, substantially all of the recurring units of the polyaryletherketones (P2) are recurring units (J′-C).

In yet another preferred embodiment of the invention, at least 5% moles of the recurring units of polyaryletherketones (P2) are recurring units (J′-D). Preferably at least 10% moles, more preferably at least 20% moles, still more preferably at least 25% moles and most preferably at least 30% moles of the recurring units of polyaryletherketones (P2) are recurring units (J′-D). Even more preferably, the polyaryletherketone (P2) contains 25% recurring units (J′-D) and 75% of recurring units (J′-A). In other embodiments, the ratio of recurring units (J′-A) to (J′-D) ranges from 95:5 to 60:40, preferably from 90:10 to 70:30, more preferably from 85:15 to 75:25. In such embodiments, the combined concentration of recurring units (J′-A) and (J′-D) is preferably at least 60% moles, 70% moles, 80% moles, 90% moles, 95% moles, 99% moles, relative to the total number of recurring units in the polyaryletherketone polymer (P2). In some aspects, recurring units (J′-A) and (J′-D) represent all of the recurring units in the polyaryletherketone polymer (P2).

Most preferably, the polyaryletherketone (P2) of the polymer composition (C) is a polyetheretherketone (PEEK), i.e. a homopolymer of recurring units (J′-A). Preferred examples of this PEEK are Ketaspire® KT-880, available from Solvay Specialty Polymers USA and Victrex® 150P available from Victrex, LTD. Excellent results were obtained when using Victrex® 150P PEEK.

In some embodiments, the polymer composition can include one or more additional polyaryletherketone polymers distinct from polyaryletherketone polymer (P2). Thus, in some such embodiments, the polymer composition includes polyaryletherketone polymer (P2*), distinct from polyaryletherketone polymer (P2). The polyaryletherketone (P2*) can be separately selected from any of the polymers described above for the polyaryletherketone polymer (P2). Preferably, the polymer composition includes a polyaryletherketone polymer (P2) including at least 50% moles, 60% moles, 70% moles, 80% moles, 90% moles, 95% moles, 99% moles, relative to the total number of recurring units in the polyaryletherketone polymer (P2), of recurring units (J′-A) and a polyaryletherketone polymer (P2*) including at least 50% moles, 60% moles, 70% moles, 80% moles, 90% moles, 95% moles, 99% moles, relative to the total number of recurring units in the polyaryletherketone polymer (P2*) of the combined concentration of recurring units (J′-A) and (J′-D). In such embodiments, the concentration of the polyaryletherketone polymer (P2) in the polymer composition can range from 1 to 99 wt. %, preferably 20 to 80 wt. %, and the concentration of the polyaryletherketone polymer (P2*) can range from 1 to 99 wt. %, preferably 20 to 80 wt. %, based on the total weight of polyaryletherketone polymers in the polymer composition. Thus, in some embodiments, the polymer composition may include both a homopolymer of recurring units (J′-A) (PEEK) and copolymer of recurring units (J′-A) and (J′-D) (PEEK-PEDEK).

### The Impact Modifier (IM)

For the purposes of the present description, the expression “impact modifier” denotes any material that is able to improve the resistance to deformation or breaking of another material.

A person skilled in the art of polymer blending will be able to choose impact modifier (IM) on a case-by-case basis in view of the common general knowledge.

In compositions (C), impact modifier (IM) is typically selected from:
a block copolymer comprising styrene units and rubber monomer units [impact modifier (IM-1)];
an acrylic elastomeric copolymer [mpact modifier (IM-2)].

Impact modifier (IM-1) may have a linear structure of the A-B-A block type (i.e. (styrene/rubber/styrene) or a branched structure of the type (A-B)ₙ (styrene rubber) or a diblock structure of the type A-B (styrene rubber) or a combination of the three.

The rubber monomer units can be selected from butadiene or isoprene units or from a combination of ethylene with butylene and ethylene with propylene.

Impact modifiers (IM-1) comprising butadiene or isoprene units are available on the market from Kraton Polymers as Kraton® D polymers, while impact modifiers comprising ethylene/butylene or ethylene/propylene units are available on the market as Kraton® G polymers.

Advantageously, in compositions (C), impact modifier (M1) is comprises styrene units and ethylene/butylene units. Excellent results were obtained using a triblock copolymer with structure of the type styrene-ethylene/butylene-styrene, available on the market with trade mark Kraton® G 1651.

Impact modifier (IM-2) is typically an elastomer selected from the following copolymers:

(i) elastomeric copolymers having glass transition temperature below 25° C., when measured according to according to ASTM D 3418, and comprising recurring units derived from one or more than one acrylic monomer selected from the group consisting of alkyl(meth)acrylates and acrylonitrile; and

(ii) core-shell elastomers, including a central core and a shell at least partially surrounding the core, said core and said shell having different monomeric composition, and at least one of them being of elastomeric nature with a glass transition temperature below 25° C., when measured according to according to ASTM D 3418, and at least one of them comprising recurring units derived from one or more than one acrylic monomer selected from the group consisting of alkyl(meth)acrylates and acrylonitrile.

In one embodiment, impact modifier (IM-2) is an elastomeric copolymer (i) as defined above. Among elastomeric copolymers (i), mention can be notably made of:

(i-A) elastomers consisting essentially of recurring units derived from acrylonitrile and recurring units derived from one or more than one monomer selected from the group consisting of ethylene, butadiene, isoprene, (meth)acrylate monomers and styrene; and

(ii-B) elastomers consisting essentially of recurring units derived from one or more than one (meth)acrylate monomers and recurring units derived from one or more than one monomers selected from ethylene, butadiene, isoprene, acrylonitrile and styrene.

The expression (meth)acrylate monomers is hereby used to denote monomers of general formula CH₂═C(R_{M})—C(═O)—R_{MA}, wherein R_{M} is H or CH₃ and R_{MA} is a hydrocarbon group, possibly comprising one or more than one heteroatoms selected from O, S, halogen or R_{MA} is H (i.e. providing for (meth)acrylic acid).

Hydrocarbon group R_{MA} is not particularly limited and encompasses notably alkyl groups (and in this case the (meth)acrylate monomer will be referred to as an alkyl (meth)acrylate), hydroxy-alkylgroups, epoxy-containing hydrocarbon groups, and the like.

Non-limitative examples of (meth)acrylate monomers wherein R_{MA} is an hydroxyl-alkylgroup are notably hydroxyethyl (meth)acrylate and hydroxypropyl (meth)acrylate isomers.

Examples of elastomers (ii-B) are notably ethylene-acrylic ester-glycidyl methacrylate elastomers.

Advantageously, impact modifier (M-2) is an elastomer (ii-B). Such elastomers are available from Arkema with trade mark Lotader®. Excellent results were obtained using Lotader® AX 8900, a random terpolymer of ethylene, acrylic ester (24% wt) and glycidyl methacrylate (8% wt).

In another embodiment, impact modifier (IM-2) is a core-shell elastomer (ii) as defined above.

As said, these core-shell elastomers are provided in the form of particles having a size of generally from 0.2 μm to 5 μm, preferably from 0.1 μm to 1 μm.

According to a preferred embodiment, the core-shell elastomers are composed of an elastomeric core and of a thermoplastic shell.

The elastomeric core is generally selected from:
elastomeric diene homopolymers or copolymers, generally selected from the group consisting of isoprene or butadiene homopolymers, isoprene copolymers with at most 30 mol percent of a vinyl monomer and butadiene copolymers with at most 30 mol percent of a vinyl monomer. The vinyl monomer may be styrene, an alkyl styrene, acrylonitrile or a (meth)acrylate monomer, as above detailed, preferably an alkyl(meth)acrylate;
homopolymers of alkyl(meth)acrylate different from MMA and copolymers of said alkyl(meth)acrylate different from MMA with at most 30 mol percent of a monomer selected from another alkyl(meth)acrylate, and a vinyl monomer. Advantageously, the alkyl(meth)acrylate different from MMA is butyl acrylate. The vinyl monomer may be styrene, an alkyl styrene, acrylonitrile, butadiene or isoprene.

The elastomeric core of the core-shell copolymer may be completely or partly crosslinked.

To achieve crosslinking of the elastomeric core, a possible practice is to incorporate at least one difunctional monomer during polymerization leading to said elastomeric core; it is possible for these difunctional monomers to be selected from poly(meth)acrylic esters of polyols such as butylene di(meth)acrylate and trimethylolpropane trimethacrylate. Other suitable difunctional monomers are, for example, divinylbenzene, trivinylbenzene, vinyl acrylate and vinyl methacrylate.

The elastomeric core may also be crosslinked by introducing into it, by grafting or as comonomer during polymerisation, unsaturated functional monomers such as unsaturated carboxylic acid anhydrides, unsaturated carboxylic acids and unsaturated epoxides. For example, mention may be made of maleic anhydride, (meth)acrylic acid and glycidyl methacrylate.

The thermoplastic shell can be notably any of styrene, alkyl styrene or methyl methacrylate homopolymers or copolymers containing at least 70 mol percent of one of these monomers mentioned above and at least one comonomer selected from the other monomers mentioned above, another alkyl(meth)acrylate, vinyl acetate and acrylonitrile. The shell may be functionalised by introducing therein, by grafting or as comonomer during polymerisation, unsaturated functional monomers such as unsaturated carboxylic acid anhydrides, unsaturated carboxylic acids and unsaturated epoxides. As examples, mention may be made of maleic anhydride, (meth)acrylic acid and glycidyl methacrylate.

Examples of copolymers and their method of preparation are described in the following patents: U.S. Pat. No. 4,180,494, U.S. Pat. No. 3,808,180, U.S. Pat. No. 4,096,202, U.S. Pat. No. 4,260,693, U.S. Pat. No. 3,287,443, U.S. Pat. No. 3,657,391, U.S. Pat. No. 4,299,928, U.S. Pat. No. 3,985,704, U.S. Pat. No. 5,773,520.

Advantageously, the core represents 70 to 90 percent and the shell 30 to 10 percent by weight of the core-shell elastomer.

As examples of a specific core-shell elastomer which can be used, mention may be made of:

(1) a core-shell elastomer which is made of:

(i) from 25 to 95 weight percent of an acrylic rubber core:
said core comprising from 90 to 100% wt of recurring units derived from a C₁-C₆ acrylate (preferably butyl acrylate);
said core being possibly cross-linked with 0.1 to 5% wt of a cross-linking monomer having a plurality of addition polymerizable reactive groups, all of which polymerize at substantially same reaction rate, preferably selected from poly acrylic and poly methacrylic esters of polyols (preferably butylene diacrylate, butylene dimethacrylate, trimethylol propane trimethacrylate); di- and tri-vinyl benzene, vinyl acrylate and vinyl methacrylate; and
said core possibly further containing 0.1 to 5% wt of a graft-linking monomer, i.e. a polyethylenically unsaturated monomer having a plurality of addition polymerizable reactive groups, at least one of which polymerizing at substantially lower rate of said reactive group, so providing a residual level of unsaturation in the elastomeric phase to enable grafting of the thermoplastic shell, said graft-linking monomer being preferably selected from allyl-group containing monomers, in particular allyl esters of ethylenically unsaturated acids (preferably allyl acrylate, allyl methacrylate, diallyl maleate, diallyl fumarate, diallyl itaconate); and

(ii) from 75 to 5 weight percent of a thermoplastic shell, said shell consisting of a polymer comprising at least 70% weight of recurring units derived from a C₁ to C₄ alkyl methacrylate (preferably methyl methacrylate), possibly in combination with less than 30% wt of recurring units derived from any of styrene, acrylonitrile, alkyl acrylate, allyl methacrylate, diallyl methacrylate;

(2) a core-shell elastomer which is made of:

(i) from 25 to 95 weight percent of a 1,3-butadiene elastomer-based core:
said core comprising at least 70% wt of recurring units derived from 1,3-butadiene, and less than 30% wt of recurring units derived from monomers other than 1,3-butadiene, selected from the group consisting of styrene, acrylonitrile and methyl methacrylate (preferably styrene);
said core possibly comprising minor amounts (e.g. of 0.01 to 1% wt) of recurring units from one or more polyunsaturated cross-linking monomers, e.g. divinylbenzene; and

(ii) from 75 to 5 weight percent of a thermoplastic shell, said shell being made of any of (k) a methyl methacrylate homopolymer, possibly modified with a minor amount (e.g. from 0.1 to 1% wt) of a cross-linking monomer, preferably selected from poly acrylic and poly methacrylic esters of polyols (preferably butylene diacrylate, butylene dimethacrylate, trimethylol propane trimethacrylate), (kk) a polymer of styrene, acrylonitrile and methylmethacrylate, and (kkk) a styrene homopolymer, possibly modified with a minor amount (e.g. from 0.1 to 1% wt) of a cross-linking monomer, preferably selected from divinylbenzene;

(3) a core-shell elastomer which comprises

(j) 75 to 80 parts by weight of a core comprising at least 94% wt of recurring units derived from 1,3-butadiene, 5% wt or less of recurring units derived from styrene, and 0.5 to 1% wt percent of recurring units derived from divinylbenzene and

(jj) 25 to 20 parts by weight of two shells, generally of identical weight fraction, the inner one made of polystyrene and the other outer one made of a methyl methacrylate homopolymer, possibly modified with a minor amount (e.g. from 0.1 to 1% wt) of a cross-linking monomer, preferably selected from poly acrylic and poly methacrylic esters of polyols (preferably butylene diacrylate, butylene dimethacrylate, trimethylol propane trimethacrylate).

There are also other types of core-shell copolymers such as hard/soft/hard copolymers, that is to say they have, in this order, a hard core, a soft shell and a hard shell. The hard parts may comprise the polymers of the shell of the above soft/hard copolymers and the soft part may comprise the polymers of the core of the above soft/hard copolymers. Non-limiting examples of such core-shell polymers comprise in order:
a core made of a methyl methacrylate/ethyl acrylate copolymer;
a shell made of a butyl acrylate/styrene copolymer; and
a core made of a methyl methacrylate/ethyl acrylate copolymer.

There are also other types of core-shell copolymers such as hard (core)/soft/semi-hard copolymers. Compared with the previous ones, the difference stems from the “semi-hard” outer shell which comprises two shells, one being the intermediate shell and the other the outer shell. The intermediate shell is a copolymer of methyl methacrylate, styrene and at least one monomer selected from alkyl acrylates, butadiene and isoprene. The outer shell is a PMMA homopolymer or copolymer. Non-limiting examples of such copolymers comprise in order:
a core made of a methyl methacrylate/ethyl acrylate copolymer;
a shell made of a butyl acrylate/styrene copolymer;
a shell made of a methyl methacrylate/butyl acrylate/styrene copolymer; and
a shell made of a methyl methacrylate/ethyl acrylate copolymer.

Excellent results were obtained with PARALOID® EXL-3361 is a pelletized butyl acrylate-based impact modifier available from Dow.

### Optional Ingredients in Composition (C)

Composition (C) according to the invention may optionally comprise other ingredients, such as other polymers, pigments and dyes, stabilizers and fillers and combinations thereof.

Among the other polymers that can be included in composition (C) mention can be made of polysulfones (PSU), in particular polyphenylsulfones (PPSU), polyetherimides (PEI) and combinations thereof. PSU and PPSU polymers suitable for use in composition (C) can be selected from those commercially available from Solvay Specialty Polymers USA, LLC, while PEI polymers can be selected from those commercially available from Sabic.

In one embodiment, composition (C) comprises a polyetherimide (PEI) polymer [PEI polymer (P3)].

For the purpose of the present invention, the term “polyether imide” is intended to denote any polymer of which more than 50 wt. % of the recurring units [recurring units (R3)] comprise at least one aromatic ring, at least one imide group, as such and/or in its amic acid form, and at least one ether group.

PEI polymers (P3) suitable for use in compositions (C) and methods for their manufacture are disclosed, for example, in U.S. Pat. No. 3,838,097 and in U.S. Pat. No. 3,847,867, herein incorporated by reference.

Preferred PEI polymers (P3) suitable for use in compositions (C) comprise recurring units of formula (R3-a):

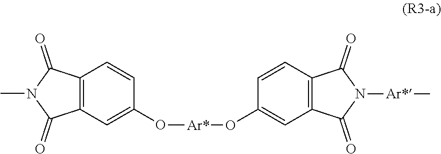

in which Ar* and Ar*′, equal to or different from another, are a substituted or unsubstituted monoarylene moiety, such as p-phenylene and m-phenylene, or a diarylene moiety like biphenyl, bisphenol A and bisphenol S. The above formula (R3-a) is intended to comprise isomers wherein the —O—Ar*—O— moiety is attached to the 3 and 3′ positions of the aromatic moieties. Non-limiting examples of substituents of moieties Ar* and Ar*′ are independently selected from one or more halogens and/or one or more C₁-C₃ straight or branched (halo)alkyl groups.

Preferred PEI polymers (P3) are conveniently obtained by reaction of an aromatic bis(ether anhydride) of formula:

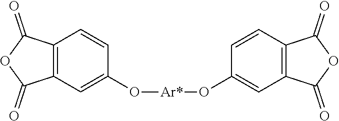

wherein Ar* is as defined above

with one or more aromatic diamines H₂N—Ar*′—NH₂ wherein Ar*′ is as defined above. Preferred PEI polymers (P3) may also comprise recurring units derived from other aromatic anhydrides, such as benzene tetracarboxylic acid dianhydride, benzophenone tetracarboxylic acid anhydride, diphenylether tetracarboxylic acid dianhydride, naphthalene tetracarboxylic acid anhydride. Such other units can be comprised in an amount up to 50% mole, preferably up to 25% mole.

Excellent results were obtained with a PEI polymer (P3) comprise repeating units of formula (R3-a′):

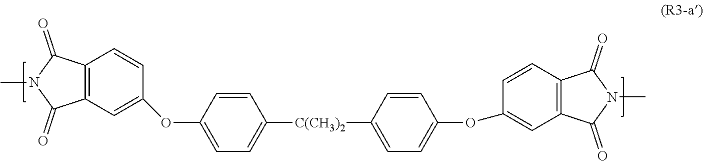

commercially available from Sabic with trade mark Ultem®, in particular with Ultem® PEI 1010-1000.

Typically, in another embodiment, composition (C) comprises an inorganic pigment. Among inorganic pigments, mention can be made of zinc sulfide (ZnS) and titanium dioxide (TiO₂). Advantageously, the pigment is TiO₂.

According to a preferred embodiment, composition (C) comprises a (PEI) polymer (P3) and TiO₂.

### Amounts of Ingredients in Composition (C)

In some embodiments, the PAEK polymer (P2) is present in an amount ranging from about 5 to about 50 wt. %, preferably about 10 to about 40 wt. %, preferably about 15 to about 35 wt. %, preferably about 20 to about 30 wt. % of the sum of the weights of PC polymer (P1) and a PAEK polymer (P2).

The amount of impact modifier (IM) in composition (C) may range from about 5 to about 25 wt. %, preferably about 10 to about 20 wt. % of the sum of the weights PC polymer (P1), PAEK polymer (P2), and impact modifier (IM).

The overall amount of optional ingredients in composition (C) may range from 0.1% to 25% wt, advantageously from 3% to 15% wt with respect to the overall weight of polymer (P1)+polymer (P2)+impact modifier (IM).

### Method of Manufacturing Composition (C)

Composition (C) according to the invention can be advantageously manufactured by melt-mixing a polycarbonate (P1), a PAEK polymer (P2), an impact modifier (IM) and any other optional ingredient at a temperature above the melting temperature of the PAEK polymer (P2) to provide a molten mixture, followed by extrusion and cooling of the molten mixture.

Accordingly, the present invention relates to a method [method (M)] which comprises melt-mixing:

a) a polycarbonate polymer [PC polymer (P1)];

b) a polaryletherketone polymer [PAEK polymer (P2)];

c) an impact modifier [impact modifier (IM)] and

any other optional ingredients defined above

at a temperature above the melting temperature of the PAEK polymer (P2) to provide a molten mixture, followed by extrusion and cooling of the molten mixture.

For the purpose of the invention the expression “a temperature above the melting temperature of the PAEK polymer (P2)” means preferably a temperature of at least 10° C. above the melting temperature of the PAEK polymer (P2), more preferably ranging from 10° C. to 50° C. above the melting temperature of the PAEK polymer (P2).

It has unexpectedly and surprisingly found out the degradation of the polycarbonate (P1) and of the impact modifier (IM) during processing did not occur when keeping the temperature of the molten mixture above the melting temperature of the PAEK polymer (P2). In particular, it has been observed that compositions (C) are endowed with very high toughness, in particular they showed values of Notched Izod Impact lower than 200 J/m. It has also been observed that, the higher the processing temperature, the higher the toughness.

For the avoidance of doubt, the temperature of the melt-mixing step is the actual temperature of the molten mass of all ingredients, said temperature being reached both by heating the container (typically a barrel) in which mixing is carried out and by means of the shearing forces applied during mixing.

Composition (C) is advantageously provided in the form of pellets.

### Formed Articles Comprising Composition (C)

As stated above, composition (C) can be used for the manufacture of formed articles, in particular parts of electronic devices, more particularly parts of portable or mobile electronic devices.

The term “mobile electronic device” is intended to denote any electronic device that is designed to be conveniently transported and used in various locations while exchanging/providing access to data, e.g. through wireless connections or mobile network connection. Representative examples of mobile electronic devices include mobile phones, personal digital assistants, laptop computers, tablet computers, radios, cameras and camera accessories, watches, calculators, music players, global positioning system receivers, portable games, hard drives and other electronic storage devices, and the like. The at least one part of the mobile electronic device according to the present invention may be selected from a large list of articles such as fitting parts, snap fit parts, mutually moveable parts, functional elements, operating elements, tracking elements, adjustment elements, carrier elements, frame elements, switches, connectors and (internal and external) components of housing, which can be notably produced by injection molding, extrusion or other shaping technologies.

In particular, the polymer composition (C) is very well suited for the production of housing components of mobile electronic device.

Therefore, the at least one part of the mobile electronic device according to the present invention is advantageously a component of a mobile electronic device housing. By “mobile electronic device housing” is meant one or more of the back cover, front cover, antenna housing, frame and/or backbone of a mobile electronic device. The housing may be a single component-article or, more often, may comprise two or more components. By “backbone” is meant a structural component onto which other components of the device, such as electronics, microprocessors, screens, keyboards and keypads, antennas, battery sockets, and the like are mounted. The backbone may be an interior component that is not visible or only partially visible from the exterior of the mobile electronic device. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas. Housing components may also be designed for their aesthetic appearance and touch.

In a preferred embodiment, the mobile electronic device housing is selected from the group consisting of a mobile phone housing, a tablet housing, a laptop computer housing and a tablet computer housing. Excellent results were obtained when the part of the mobile electronic device according to the present invention was a mobile phone housing.

### Methods for the Manufacture of Formed Articles

The formed articles obtained from (or comprising) compositions (C) are manufactured by moulding compositions (C).

For this purpose, any standard moulding technique can be used; standard techniques including shaping composition (C) in a molten/softened form can be advantageously applied, and include notably compression moulding, extrusion moulding, injection moulding, transfer moulding and the like.

It is nevertheless generally understood that especially when said part of the mobile electronic device possesses a complex design, the injection moulding technique is the most versatile and extensively used. According to this technique, a ram or screw-type plunger is used for forcing a portion of composition (C) in its molten state into a mould cavity, wherein the same solidified into a shape that has confirmed to the contour of the mould. Then, the mould opens and suitable means (e.g. an array of pins, sleeves, strippers, etc.) are driven forward to demould the article. Then, the mould closes and the process is repeated.

In another embodiment of the present invention, the method for manufacturing a part of an electronic device includes in step (ii) a step of machining of a standard shaped article so as to obtain said part having different size and shape from said standard shaped article. Non limiting examples of said standard shaped articles include notably a plate, a rod, a slab and the like. Said standard shaped parts can be obtained by any processing technique, including notably extrusion or injection moulding of the polymer composition (C).

The parts of the electronic devices according to the present invention may be coated with metal by any known methods for accomplishing that, such as vacuum deposition (including various methods of heating the metal to be deposited), electroless plating, electroplating, chemical vapor deposition, metal sputtering, and electron beam deposition. Hence, the method, as above detailed, may additionally comprise at least one additional step comprising coating at least one metal onto at least a part of the surface of the said part.

Although the metal may adhere well to the parts without any special treatment, usually some well-known in the art methods for improving adhesion can be used. This may range from simple abrasion of the surface to roughen it, addition of adhesion promotion agents, chemical etching, functionalization of the surface by exposure to plasma and/or radiation (for instance laser or UV radiation) or any combination of these.

Also, some of the metal coating methods comprise at least one step where the part is immersed in an acid bath. More than one metal or metal alloy may be plated onto the parts made of the polymer composition (C), for example one metal or alloy may be plated directly onto the surface because of its good adhesion, and another metal or alloy may be plated on top of that because it has a higher strength and/or stiffness. Useful metals and alloys to form the metal coating include copper, nickel, iron-nickel, cobalt, cobalt-nickel, and chromium, and combinations of these in different layers. Preferred metals and alloys are copper, nickel, and iron-nickel, and nickel is more preferred. The surface of the part may be fully or partly coated with metal. In different areas of the part the thickness and/or the number of metal layers, and/or the composition of the metal layers may vary. The metal may be coated in patterns to efficiently improve one or more properties in certain sections of the part.

The part, as obtained from the method above, is generally assembled with other components in order to manufacture an electronic device, in particular a mobile electronic device.

Therefore, a further object of the invention is the manufacture of an electronic device, in particular a mobile electronic device, said method including the steps of:

a. providing as components at least a circuit board, a screen and a battery;

b. providing at least one part made of the polymer composition (C), as described above;

c. assembling at least one of said components with said part or mounting at least one of said components on said part.

### Chemical and Mechanical Properties

The polymer composition may exhibit improved impact performance. While it is often desirable that mobile electronic devices (and parts thereof) be small and lightweight, excellent structural strength is highly desirable so that device will not be damaged in normal handling and occasional sudden impact (e.g. drops). Correspondingly, structural parts are generally built into mobile electronic devices that impart strength, rigidity, and/or impact resistance to the device, and possibly also provide mounting places for various internal components of the device and/or part or all of the mobile electronic device case (e.g., outer housing), while ensuring electrical insulation/electrical shielding among components. In some embodiments, the polymer composition may have a notched Izod impact resistance of at least 200 Joules/meter (“J/m”), preferably at least 300 J/m, preferably at least about 450 J/m, preferably at least about 500 J/m, preferably at least about 550 J/m, preferably at least about 600 J/m, preferably at least about 650 J/m, preferably at least about 700 J/m. In some aspects, the polymer composition has a notched Izod impact resistance ranging from about 200 J/m to about 900 J/m, preferably about 450 J/m to about 900 J/m, preferably about 550 J/m to about 900 J/m. A person of ordinary skill in the art will recognize additional notched Izod impact resistance ranges within the explicitly disclosed ranges are contemplated and within the scope of the present disclosure. Impact resistance can be measured using a notched Izod impact test according the ASTM D256 standard, as described further in the Examples.

The polymer compositions also have desirable colorability. In some embodiments, the polymer compositions have desirable whiteness, with a CIE L* value ranging from 90.0 to 94.0, preferably, 91.0 to 94.0, preferably 92.0 to 94.0. A person of ordinary skill in the art will recognize additional L* ranges within the explicitly disclosed ranges are contemplated and within the scope of the present disclosure.

In some aspects, the polymer composition has a Sunscreen Test strain to fail % (as described in the Examples) of greater than or equal to 1.5%, preferably greater than or equal to about 1.7%, preferably greater than or equal to about 1.9%, preferably greater than or equal to about 2.0%.

In exemplary embodiments, the polymer composition exhibits a combination of a notched-Izod impact not less than about 450 J/m, a Sunscreen Test strain to fail greater than or equal to 2.0%, a mustard staining Delta E less than or equal to about 2.0, and a CIE color L* ranging from 93.0 to 94.0.

In particularly preferred embodiments, the polymer composition exhibits a combination of a notched Izod impact strength ranging of not less than about 200 J/m (preferably not less than about 450 J/m), a CIE L* value ranging from 90.0 to 94.0 (preferably from about 92.0 to about 94.0), and a Sunscreen Test strain to fail % greater than or equal to about 2.0%.

The invention will be herein after illustrated in greater detail in the following section by means of non-limiting examples.

Should the disclosure of any patents, patent applications, and publications which are incorporated herein by reference conflict with the description of the present application to the extent that it may render a term unclear, the present description shall take precedence.

### EXPERIMENTAL SECTION

### Materials

The following materials were used to prepare the compositions and specimens of the examples and comparative examples:

Polycarbonate (PC)—Makrolon® 3108 from Bayer Material Sciences (a PC having a specification melt flow range of 4.9 to 8.4 g/10 min. as measured according to ASTM D1238 at a temperature of 300° C. and 1.2 kg weight)

Polyetheretherketone (PEEK)—Victrex® 150P from Victrex PLC (a PEEK having a melt viscosity of 130 Pa·s as measured according to IS011443 at 400° C.)

Polyetherimide (PEI)—Ultem® 1010-1000 from Sabic Innovative Plastics. (PEI having a melt flow range of 17.8 g/10 min. as measured according to ASTM D1238 at a temperature of 337° C. and 6.6 kgf)

Impact Modifier A—Lotader® AX8900 [random terpolymer of ethylene, acrylic ester (24 wt. %) and glycidyl methacrylate (8 wt. %)]

Impact Modifier B—Paraloid® EXL3361 from Dow [a butyl acrylate based core shell impact modifier]

Impact Modifier C—Kraton® G1651 from Kraton Polymers [a styrenic block copolymer with a hydrogenated midblock of styrene-ethylene/butylene-styrene (SEBS)]

Titanium Dioxide (TiO₂)—Grade: Kronos® 2233 from Kronos Corp.

### General Method for the Preparation of the Compositions

The polymer compositions of the examples and comparative examples were prepared by first drying the polymer ingredients for at least 16 hours in desiccated ovens. PC was dried at a temperature of 175° F., PEEK at 300° F. and the impact modifiers at 140° F. Following drying the ingredients of each example were tumble-blended for about 20 minutes. Following that, each material was subjected to melt compounding using a 26 mm diameter Coperion® ZSK-26 co-rotating partially intermeshing twin screw extruder having an L/D ratio of 48:1. The barrel sections 2 through 12 and the die were heated to set point temperatures as follows:

Barrels 2-6: 360° C.

Barrels 7-12: 340° C.

Die: 340° C.

In each case, the resins and additives were fed at barrel section 1 using a gravimetric feeder at throughput rates in the range 30-40 lb/hr. The extruder was operated at screw speeds of around 200 RPM. Vacuum was applied at barrel zone 10 with a vacuum level of about 27 inches of mercury. A single-hole die was used for all the materials and the molten polymer strand exiting the die was cooled in a water trough and then cut in a pelletizer to form pellets approximately 3.0 mm in length by 2.7 mm in diameter.

### Injection Molding

Injection molding was performed on the example and comparative examples formulations for the purpose of producing 3.2 mm (0.125 in) thick ASTM tensile and flexural specimens for mechanical property testing. Type I tensile ASTM specimens and 5 in×0.5 in×0.125 in flexural specimens were injection molded using the following approximate temperature conditions on the barrel and mold:

Rear zone: 630° F.

Middle zone: 630° F.

Front zone: 630° F.

Nozzle: 630° F.

Mold: 220° F.

The ingredients and amounts of in the compositions of the examples/comparative examples and in the specimens obtained therefrom are reported in Table 1 below.

TABLE 1
Ingredients and amounts in the compositions

| | Polycarbonate | | | Impact | Impact | Impact | |
|---|---|---|---|---|---|---|---|
| Example | (PC) | PEEK | PEI | modifier | modifier | modifier | TiO₂ |
| n^{o} | (% wt) | (% wt) | (% wt) | A (% wt) | B (% wt) | C (% wt) | (pph) |
| CE-1 | 75 | 20 | 5 | / | / | / | 6 |
| CE-2 | 62.5 | 30 | 7.5 | / | / | / | 6 |
| E-1 | 53.1 | 25.5 | 6.4 | 15 | / | / | 4 |
| E-2 | 53.1 | 25.5 | 6.4 | / | 15 | / | 4 |
| E-3 | 56.25 | 27 | 6.75 | 10 | / | / | 2 |
| E-4 | 56.25 | 27 | 6.75 | / | 10 | / | 2 |
| E-5 | 50 | 24 | 6 | 20 | / | / | 6 |
| E-6 | 50 | 24 | 6 | / | 20 | / | 6 |
| E-7 | 56.25 | 27 | 6.75 | 10 | / | | 6 |
| E-8 | 56.25 | 27 | 6.75 | / | 10 | / | 6 |
| E-9 | 57.5 | 27.5 | 6.75 | 15 | / | / | 4 |
| E-10 | 66.5 | 28.5 | / | / | 5 | / | 4 |
| E-11 | 63 | 27 | / | / | 10 | / | 4 |
| E-12 | 57.5 | 22.5 | / | / | 10 | / | 4 |
| E-13 | 66.5 | 28.5 | / | / | / | 5 | 4 |
| E-14 | 67.5 | 22.5 | / | / | / | 10 | 4 |

### Testing

Mechanical properties were tested for all the compositions using injection molded 0.125 inch thick ASTM test specimens which consisted of 1) Type I tensile bars, 2) 5 in×0.5 in×0.125 in flexural bars, and 3) 4 in×4 in×0.125 in plaques for the instrumented impact (Dynatup) testing. The following ASTM test methods were employed in evaluating all compositions:

D-638: Tensile properties: tensile strength at break, tensile modulus and tensile elongation at break;

D-256: Notched Izod impact resistance.

As-molded color of each formulation was measured to assess the whiteness of the compositions. The color was measured according to the CIE L-a-b coordinates standard where the L* coordinate represents the lightness (black to white) scale, the a* coordinate represents the green-red chromaticity and the b* scale represents the blue-yellow chromaticity. The whiteness of the material is considered acceptable if the L* value is greater than 90.0 and the combined absolute values of the chromaticity coordinates a* and b* are less than 4.0 units. Of course, the whiteness will increase with increasing level of the TiO₂ pigment in the formulation, and 5-6 phr levels are considered moderately low levels of this pigment.

Chemical resistance of the formulations was tested in two ways. Chemical resistance against sunscreen lotion was tested by applying Banana Boat® SPF30 broad spectrum sunscreen cream to ASTM flexural bars that have been mounted onto parabolic flexural jigs (Bergen jigs) that vary the applied strain on the plastic material from near zero to 2.0%. These stressed assemblies were aged in a controlled humidity environmental chamber at a temperature of 65° C. and relative humidity of 90% for a duration of 24 hours, after which the assemblies were removed from the chamber and the flexural bars mounted on the strain jigs were inspected for any signs of cracking or crazing. Critical strain to failure was recorded as the lowest strain level on the parabola on which cracking or crazing was observed.

The second chemical resistance test conducted was an acid bath immersion test in which Type I ASTM tensile specimens were immersed in 70% sulfuric acid at 23° C., after which the specimens were removed, washed with water, then tested for their tensile properties. The tensile properties before and after this acid exposure served as an indicator of the material's ability to withstand the anodizing steps applied in mobile phone manufacturing steps when the phone is comprised of a combination of metal and plastic parts, where the plastic material has to undergo exposure to the chemical conditions of the anodizing baths—typically comprising various strong acidic environments.

### Results

Test results are reported in Tables 2-4 below.

TABLE 2
Mechanical properties

| | Tensile | Tensile | Tensile | Notched | |
|---|---|---|---|---|---|
| Example | strength | Modulus | Elongation | Izod Impact | Break |
| n^{o} | (MPa) | (GPa) | at break (%) | (J/m) | Type |
| CE-1 | 69 | 2.6 | 76 | 96 | Complete |
| CE-2 | 72 | 2.8 | 61 | 82 | Complete |
| E-1 | 48.7 | 1.8 | 73 | 566 | Partial |
| E-2 | 55.1 | 2.2 | 57 | 716 | Partial |
| E-3 | 54.8 | 2.0 | 82 | 897 | Partial |
| E-4 | 62.1 | 2.4 | 83 | 790 | Partial |
| E-5 | 41.9 | 1.6 | 63 | 561 | Partial |
| E-6 | 46.9 | 1.9 | 48 | 469 | Partial |
| E-7 | 53.2 | 2.0 | 79 | 489 | Partial |
| E-8 | 58.3 | 2.3 | 61 | 662 | Partial |
| E-9 | 48.3 | 1.8 | 65 | 539 | Partial |
| E-10 | 63.3 | 2.5 | 75 | 694 | Partial |
| E-11 | 56.5 | 2.3 | 75 | 577 | Partial |
| E-12 | 54.3 | 2.2 | 78 | 614 | Partial |
| E-13 | 64.6 | 2.5 | 78 | 249 | Partial |
| E-14 | n.t. | n.t. | n.t. | n.t. | n.t. |

n.t. = not tested

TABLE 3
As-molded color

| Example n^{o} | CIE color, L* | CIE color, a* | CIE color b* |
|---|---|---|---|
| CE-1 | 93.8 | −0.15 | 3.3 |
| CE-2 | 93.2 | −0.06 | 3.6 |
| E-1 | 91.4 | −0.1 | 3.9 |
| E-2 | 92.2 | −0.2 | 3.4 |
| E-3 | 90.4 | 0.0 | 4.3 |
| E-4 | 90.4 | 0.0 | 3.9 |
| E-5 | 93.1 | −0.1 | 3.7 |
| E-6 | 94.0 | −0.2 | 3.4 |
| E-7 | 92.2 | −0.1 | 4.5 |
| E-8 | 93.4 | −0.1 | 3.8 |
| E-9 | 92.1 | 0.2 | 3.5 |
| E-10 | 92.2 | 0.2 | 3.3 |
| E-11 | 93.1 | 0.1 | 3.5 |
| E-12 | 93.2 | 0.0 | 3.3 |
| E-13 | 93.4 | 0.2 | 3.9 |
| E-14 | n.t. | n.t. | n.t. |

n.t. = not tested

TABLE 4
Chemical resistance

| | | Tensile properties | | |
|---|---|---|---|---|
| | | post acid treatment | | |
| | Sunscreen | | | Tensile |
| | test, | Tensile | Tensile | elongation |
| Example | Strain to | Strength | modulus | at break |
| n^{o} | fail (%) | (MPa) | (GPa) | (%) |
| CE-1 | 1 | n.t. | n.t. | n.t. |
| CE-2 | 1.1 | n.t. | n.t. | n.t. |
| E-1 | N.E. | 48.2 | 1.9 | 63 |
| E-2 | N.E. | 54 | 2.2 | 67 |
| E-3 | N.E. | 54.2 | 2.1 | 76 |
| E-4 | N.E. | 61.4 | 2.4 | 84 |
| E-5 | N.E. | 41.9 | 1.6 | 59 |
| E-6 | N.E. | 47 | 2.0 | 50 |
| E-7 | N.E. | n.t. | n.t. | n.t. |
| E-8 | N.E. | n.t. | n.t. | n.t. |
| E-9 | N.E. | n.t. | n.t. | n.t. |
| E-10 | N.E. | 61.6 | 2.5 | 79 |
| E-11 | N.E. | 56.7 | 2.3 | 62 |
| E-12 | N.E. | 56.6 | 2.2 | 74 |
| E-13 | N.E. | 60 | 2.6 | 73 |
| E-14 | n.t. | n.t. | n.t. | n.t. |

N.E. = No effect up to the maximum applied strain
n.t. = not tested

### Discussion

Mechanical Properties

The results reported in Table 2 show that the compositions of the invention are endowed with excellent mechanical properties. This is unexpected and surprising because, despite the temperature of the melt-mixing step being higher than that of the PEEK polymer, the impact modifiers and the polycarbonate did not degrade as expected. None of the inventive compositions failed in a brittle manner (complete break) during the notched impact test with associated low notched Izod values.

In particular, as shown from the results reported in Table 1, the compositions of the invention are endowed with a resistance to impact at least 4.5 times higher than those which do not contain any impact modifier

Colorability

The results reported in Table 3 show that the whiteness of the formulations was excellent in all cases, with L* (lightness scale) values superior to 90.0 and where the combined absolute value of the chromaticity coordinates (a*+b*) was less than 4 units. The addition of higher levels of TiO₂ unexpectedly made it possible to achieve greater whiteness in the material without sacrificing impact resistance, chemical resistance or staining resistance of the compositions.

Chemical Resistance

It is well know that polycarbonate by itself breaks when exposed to sunscreen lotions. The results reported in Table 4 show that the addition of PEEK alone to PC was not enough to improve the chemical resistance to sunscreen lotion (CE-1 and CE-2); however, improved chemical resistance to sunscreen lotion was unexpectedly observed for all materials including an impact modifier, even at a low loading of 5%.

The acid resistance of the formulations, which is a proxy for anodizing bath resistance, was very good in all cases with no significant changes in strength and modulus (stiffness) following the acid treatment and only a slight reduction in elongation at break was observed.

1-15. (canceled)

16. A melt-mixed composition (C) comprising:
a) an aromatic polycarbonate polymer, PC polymer (P1);
b) a polyaryletherketone polymer, PAEK polymer (P2); and
c) an impact modifier (IM).

17. The melt-mixed composition (C) according to claim 16, wherein the PC polymer (P1) comprises more than 50 wt. % of recurring units (R1), and the recurring units (R1) comprise at least one optionally substituted arylene group and at least one carbonate group (—O—C(═O)—O).

18. The melt-mixed composition (C) according to claim 16, wherein the PAEK polymer (P2) comprises more than 50% moles of recurring units (R2) and the recurring units (R2) comprise a —Ar—C(═O)—Ar′— group, wherein Ar and Ar′, equal to or different from each other, are aromatic groups.

19. The melt-mixed composition (C) according to claim 18, wherein recurring units (R2) are selected from the group consisting of formulae (J-A) to (J-O): 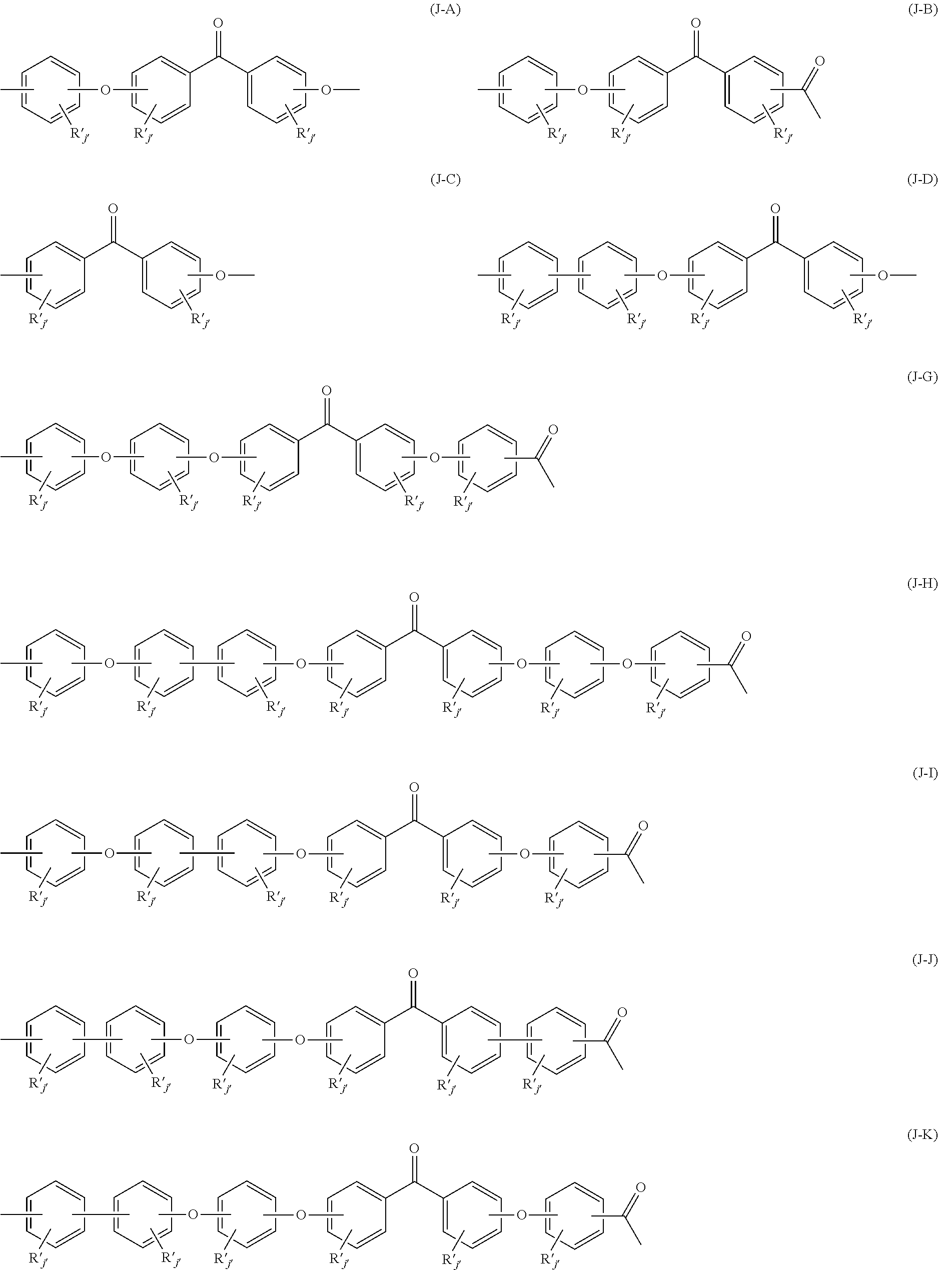 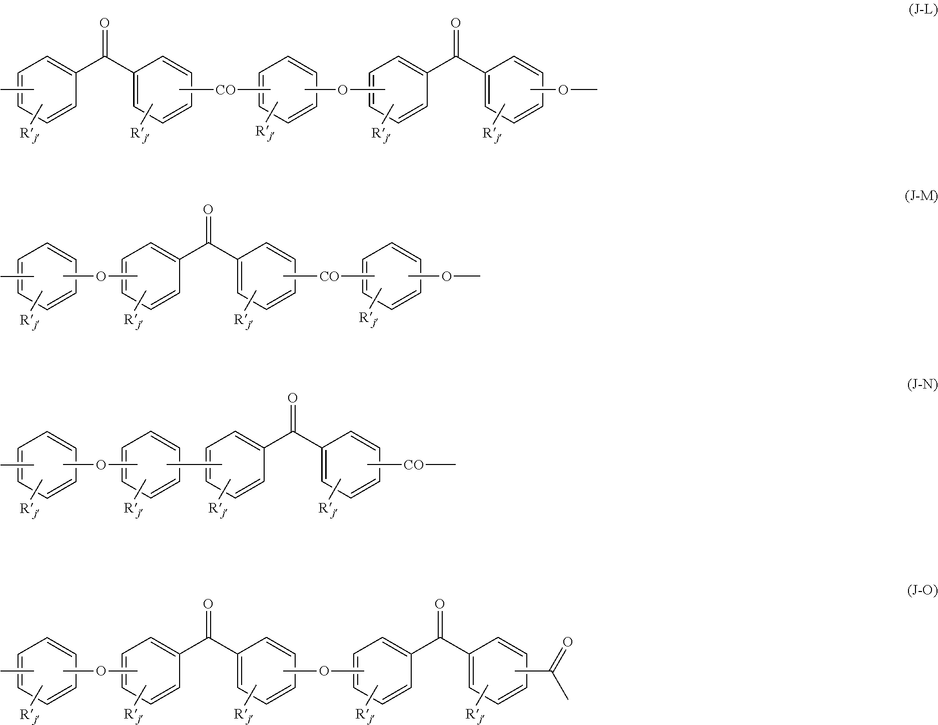
wherein: each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is zero or is an integer from 0 to 4.

20. The melt-mixed composition (C) according to claim 18, wherein the recurring units (R2) are selected from formulae (J′-A) to (J′-O):

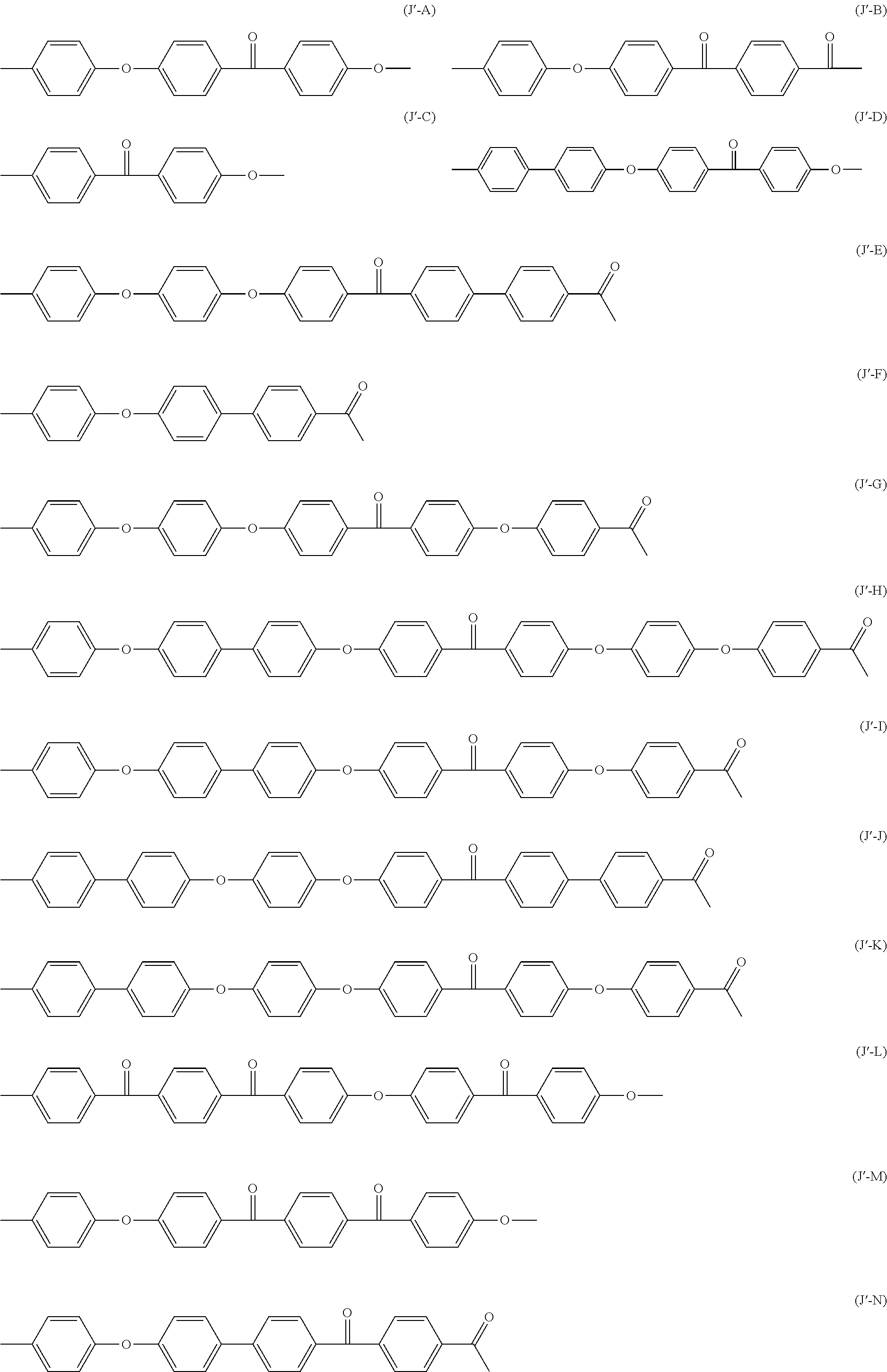

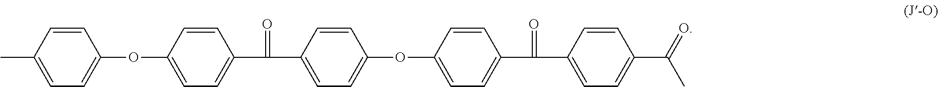

21. The melt-mixed composition (C) according to claim 20, wherein the PAEK polymer (P2) is a homopolymer of recurring units (J′-A).

22. The melt-mixed composition (C) according to claim 16 further comprising a PAEK polymer (P2*) that is a copolymer of recurring units (J′-A) and (J′-D):

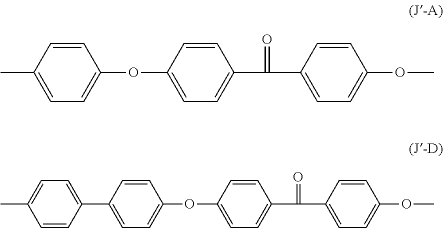

23. The melt-mixed composition (C) according to claim 16, wherein the impact modifier (IM) is selected from:
a block copolymer comprising styrene units and rubber monomer units, impact modifier (IM-1); and
an acrylic elastomeric copolymer, impact modifier (IM-2).

24. The melt-mixed composition (C) according to claim 16 comprising an impact modifier (IM-1) which is an ethylene/butylene-styrene triblock copolymer.

25. The melt-mixed composition (C) according to claim 16 comprising an impact modifier (IM-2) which is selected from the following copolymers:
(i) elastomeric copolymers having a glass transition temperature below 25° C., as measured in accordance to ASTM D 3418, and comprising recurring units derived from one or more than one acrylic monomer selected from the group consisting of alkyl(meth)acrylates and acrylonitrile; and
(ii) core-shell elastomers, including a central core and a shell at least partially surrounding the core, said core and said shell having different monomeric composition, and at least one of them being of elastomeric nature with a glass transition temperature below 25° C., as measured in accordance to according to ASTM D 3418, and at least one of the central core and/or shell comprises recurring units derived from one or more than one acrylic monomer selected from the group consisting of alkyl(meth)acrylates and acrylonitrile.

26. The melt-mixed composition (C) according to claim 16 further comprising a polyetherimide polymer, PEI polymer (P3), and TiO₂.

27. The melt-mixed composition (C) according to claim 26, wherein the PEI polymer (P3) comprises more than 50 wt. % of recurring units (R3), and the recurring units (R3) comprise at least one aromatic ring, at least one imide group, as such and/or in its amic acid form, and at least one ether group.

28. The melt-mixed composition (C) according to claim 16, wherein the recurring units (R3) are units of formula (R3-a′):
(R3-a′)

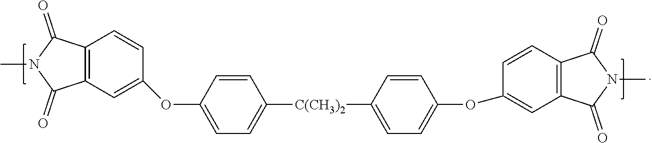

29. A method of making the melt-mixed composition (C) according to claim 16, which comprises melt-mixing:
a) an aromatic polycarbonate polymer, PC polymer (P1);
b) a polyaryletherketone polymer, PAEK polymer (P2);
c) an impact modifier (IM); and
any other optional ingredients at a temperature above the melting temperature of the PAEK polymer (P2) to form a molten mixture;
extruding the molten mixture; and
cooling the molten mixture.

30. A formed article comprising the melt-mixed composition (C) according to claim 16.

31. The formed article according to claim 30, wherein the article is part of an electronic device.
